(19) United States
(12) Patent Application Publication
(10) Pub. No.: US 2005/0284502 A1
(43) Pub. Date: Dec. 29, 2005

(54) Rinse and resist patterning process using the same

(75) Inventors: Satoshi Watanabe, Joetsu-shi (JP); Tomohiro Kobayashi, Joetsu-shi (JP); Yoshio Kawai, Joetsu-shi (JP); Toshinobu Ishihara, Joetsu-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd., Tokyo (JP)

(21) Appl. No.: 11/159,095

(22) Filed: Jun. 23, 2005

(30) Foreign Application Priority Data
Jun. 25, 2004 (JP) 2004-188253

(51) Int. Cl. C03C 23/00

(52) U.S. Cl. 134/2; 430/322

(57) ABSTRACT

A rinse comprising a water-soluble polymer is suited for use in a lithographic process. In the lithographic process for the fabrication of semiconductor integrated circuits involving the exposure of resist to various types of radiation (e.g., UV, deep UV, vacuum UV, electron beams, x-rays, and laser beams), the invention can prevent resist insoluble components from generating on and attaching to the resist film or substrate, and if insoluble components attach, can effectively remove the insoluble components, thus avoiding a lowering of production yield by defects resulting from the insoluble components.

### CROSS-REFERENCE TO RELATED APPLICATION

This non-provisional application claims priority under 35 U.S.C. §119(a) on Patent Application No. 2004-188253 filed in Japan on Jun. 25, 2004, the entire contents of which are hereby incorporated by reference.

### TECHNICAL FIELD

This invention relates to a rinse for use in a lithographic process involving the exposure of resist materials to various types of radiation (e.g., UV, deep UV, vacuum UV, electron beams, x-rays, and laser beams, typically excimer laser beams), for effectively removing resist insoluble components generated therein; and a process for forming a resist pattern using the same.

### BACKGROUND ART

Semiconductor integrated circuits have reached so great a scale of integration that large scale integrated circuits (LSI) and very large scale integrated circuits (VLSI) are now used in practice. At the same time, the minimum pattern size of integrated circuits reaches the submicron region and will become finer. Micropatterning is generally carried out by lithography, for example, by forming a thin film on a substrate, coating a resist thereon, effecting selective exposure to form a latent image of the desired pattern, developing the resist to form a resist pattern, effecting dry etching using the resist pattern as a mask, and removing the resist, leaving the desired pattern.

As the pattern feature size becomes finer, the light source has undergone a transition to shorter wavelength ones such as deep-UV, vacuum-UV, electron beams (EB) and x-rays. The latest stage of lithography considers to use as the exposure light source excimer lasers, specifically KrF laser of wavelength 248 nm and ArF laser of wavelength 193 nm or a F₂ laser of wavelength 157 nm. These lasers are expected to be effective for micropatterning.

From this standpoint, acid-catalyzed or chemically amplified resist compositions were developed (see U.S. Pat. No. 4,491,628 or JP-B 2-27660, and U.S. Pat. No. 5,310,619 or JP-A 63-27829). Because of a high sensitivity, resolution and dry etching resistance, these resist compositions are promising especially in the deep UV lithography having many advantages.

Resist compositions for forming submicron patterns using exposure radiation of a shorter wavelength, i.e., in the vacuum UV range use polymers or copolymers as a base resin. Known polymers include polymers or copolymers of acrylates or alpha-substituted acrylates having an adamantane structure and an acid-labile protective group in the ester moiety (see JP-A 4-39665) and polymers or copolymers of acrylates or alpha-substituted acrylates having a norbornane structure and an acid-labile protective group in the ester moiety (see JP-A 5-257281).

However, as the pattern feature size becomes finer, it is considered problematic that so-called defects arise from residues of resist insoluble components left after aqueous alkaline solution development and deionized water rinsing and such defects lead to reduced production yields. For solving this problem, it is, of course, desired to have a resist composition which generates only minimal amounts of insoluble components. It is also desired to incorporate in the lithographic process an effective step capable of efficiently removing once generated resist insoluble components.

### SUMMARY OF THE INVENTION

An object of the present invention is to provide a rinse, for use in a lithographic process involving the exposure of resist materials to various types of radiation, for effectively removing resist insoluble components generated therein; and a process for forming a resist pattern using the same.

The inventor has found that the resist material which has been dissolved during aqueous alkaline solution development (exposed portions of resist film in the case of positive resist, or unexposed portions of resist film in the case of negative resist) becomes insolubilized during deionized water rinsing and agglomerated and that such agglomerates deposit on and attach to the top surface and side walls of a resist pattern formed (unexposed portions of resist film in the case of positive resist, or exposed portions of resist film in the case of negative resist) and even on the substrate as foreign particles which become so-called defects, inviting a lowering of production yield.

Continuing the study, the inventor has found that use of a rinse comprising a water-soluble polymer, especially a rinse comprising a N-vinylpyrrolidone homopolymer, copolymer of N-vinylpyrrolidone with another vinyl monomer, polyvinyl alcohol, copolymer of vinyl alcohol with another vinyl monomer, poly(meth)acrylic acid or polysaccharide as the water-soluble polymer, instead of deionized water, is effective for preventing the resist material from becoming insolubilized and agglomerated, and even if resist insoluble components are generated, effective for preventing such components from attachment, and even if the resist insoluble components have attached, effective for removing the once attached components. In this way, the water-soluble polymer-based rinse avoids or alleviates a lowering of production yield by defects.

In one aspect, the present invention provides a rinse for use in a lithographic process with resist, comprising a water-soluble polymer.

In a preferred embodiment, the water-soluble polymer is selected from the group consisting of N-vinylpyrrolidone homopolymers, copolymers of N-vinylpyrrolidone with another vinyl monomer, polyvinyl alcohol, copolymers of vinyl alcohol with another vinyl monomer, poly(meth)acrylic acids, and polysaccharides. The rinse may further contain a surfactant which is typically a fluoroalkanesulfonic acid derivative or alkanesulfonic acid derivative.

In another aspect, the present invention provides a process for forming a resist pattern, comprising the steps of (a) applying a resist material onto a substrate to form a resist film, (b) prebaking the resist film, (c) exposing the prebaked resist film to a pattern of light, (d) post-exposure baking the exposed resist film, (e) developing the post-baked resist film with an aqueous alkaline solution, and (f) rinsing the developed resist film with the rinse defined herein, and further with deionized water; or a process for forming a resist pattern, comprising the steps of (a) applying a resist material onto a substrate to form a resist film, (b) prebaking the resist film, (c) exposing the prebaked resist film to a pattern of light, (d) post-exposure baking the exposed resist film, (e) developing the post-baked resist film with an aqueous alkaline solution, and (g) rinsing the developed resist film with deionized water, then with the rinse defined herein, and further with deionized water.

In the lithographic process involving the exposure of resist materials to various types of radiation (e.g., UV, deep UV, vacuum UV, electron beams, x-rays, and laser beams, typically excimer laser beams), the present invention can prevent resist insoluble components from generating and attaching, and even if resist insoluble components attach, can effectively remove the resist insoluble components. Thus, in the lithographic process using a resist for the fabrication of semiconductor integrated circuits, typically semiconductor LSIs, the present invention can avoid a lowering of production yield by defects resulting from resist insoluble components that will generate on the resist or substrate.

### DESCRIPTION OF THE PREFERRED EMBODIMENTS

The rinse liquid of the invention is intended for use in a lithographic process using resists and defined as comprising a water-soluble polymer and deionized water. The water-soluble polymer is typically selected from among N-vinylpyrrolidone homopolymers, copolymers of N-vinylpyrrolidone with a vinyl monomer other than N-vinylpyrrolidone, polyvinyl alcohol, copolymers of vinyl alcohol with a vinyl monomer other than vinyl alcohol, poly(meth)acrylic acids, and polysaccharides. Of these, N-vinylpyrrolidone homopolymers and copolymers of N-vinylpyrrolidone with another vinyl monomer are preferred.

Examples of the copolymers of N-vinylpyrrolidone with another vinyl monomer include
N-vinylpyrrolidone/vinyl acetate copolymers,
N-vinylpyrrolidone/vinyl alcohol copolymers,
N-vinylpyrrolidone/acrylic acid copolymers,
N-vinylpyrrolidone/methyl acrylate copolymers,
N-vinylpyrrolidone/methacrylic acid copolymers, N-vinylpyrrolidone/methyl methacrylate copolymers, N-vinylpyrrolidone/maleic acid copolymers, N-vinylpyrrolidone/dimethyl maleate copolymers, N-vinylpyrrolidone/maleic anhydride copolymers, N-vinylpyrrolidone/itaconic acid copolymers, N-vinylpyrrolidone/methyl itaconate copolymers, and N-vinylpyrrolidone/itaconic anhydride copolymers. Of these, N-vinylpyrrolidone/vinyl acetate copolymers are most preferred.

Examples of the copolymers of vinyl alcohol with another vinyl monomer include vinyl alcohol/acrylic acid copolymers, vinyl alcohol/methyl acrylate copolymers, vinyl alcohol/methacrylic acid copolymers, vinyl alcohol/methyl methacrylate copolymers, vinyl alcohol/maleic acid copolymers, vinyl alcohol/dimethyl maleate copolymers, vinyl alcohol/maleic anhydride copolymers, vinyl alcohol/itaconic acid copolymers, vinyl alcohol/methyl itaconate copolymers, vinyl alcohol/itaconic anhydride copolymers, and vinyl alcohol/vinyl acetate copolymers (i.e., partially saponified products of vinyl acetate).

Examples of suitable polysaccharides include cellulose ethers such as methyl cellulose, methyl cellulose hydroxypropyl methyl cellulose, hydroxypropyl methyl cellulose, and pullulan.

The water-soluble polymers may be used alone or in combination of two or more.

To the rinse of the invention, a surfactant may be added. The surfactant is preferably selected from fluoroalkanesulfonic acid derivatives and alkanesulfonic acid derivatives. Examples include fluoroalkanesulfonic acids and alkanesulfonic acids and salts thereof with nitrogen compounds.

In a preferred embodiment, the rinse contains a fluoroalkanesulfonic acid of 4 to 10 carbon atoms which is highly compatible with the water-soluble polymer. In the fluoroalkanesulfonic acids, the fluoroalkyl group may be straight, branched or cyclic, provided that at least one of hydrogen atoms attached to carbon atoms of the fluoroalkyl group is substituted with a fluorine atom, preferably all hydrogen atoms or all but one hydrogen atoms are substituted with fluorine atoms. The fluoroalkanesulfonic acids may be used alone or in admixture. Illustrative of the fluoroalkanesulfonic acid used herein is perfluorooctanesulfonic acid (available from Jemco Inc.).

In the rinse liquid of the invention, the water-soluble polymer is desirably present in a concentration of 0.5 to 30% by weight, more desirably 1 to 15% by weight, calculated as solids based on the weight of the rinse liquid, provided that when a surfactant is added, solids are total solids of both the water-soluble polymer and the surfactant. Less than 0.5 wt % of polymer solids may be less effective for removing the resist residues whereas more than 30 wt % of polymer solids leads to a higher viscosity which may require a larger load in discharging the rinse liquid.

Also, the surfactant is preferably compounded in such amounts that the solids of the water-soluble polymer and the surfactant consist of at least 20% by weight, especially 30 to 60% by weight of the water-soluble polymer and up to 80% by weight, especially 40 to 70% by weight of the surfactant, and differently stated, the weight ratio of water-soluble polymer to surfactant is in a range from 20:80 to 100:0. Within this range, it is preferred to use a weight ratio of at least 30:70 and also, a weight ratio of up to 60:40. Less than 20 wt % of the water-soluble polymer may lead to poor compatibility.

In the embodiment of the invention wherein the surfactant is further added, a basic compound may be added as a pH adjusting agent to the rinse. The preferred basic compounds are amine derivatives, especially alkanolamines of up to 10 carbon atoms. It is most preferred to use alkanolamines of up to 10 carbon atoms as the basic compound in combination with fluoroalkanesulfonic acids of 4 to 10 carbon atoms as the surfactant.

Examples of suitable alkanolamines include ethanolamine, diethanolamine, triethanolamine, 3-quinuclidinol, tropine, 1-methyl-2-pyrrolidine ethanol, 1-methyl-3-pyrrolidinol, 1-(2-hydroxyethyl)-2-pyrrolidine, 3-piperidino-1,2-propane diol, 3-pyrrolidino-1,2-propane diol, and 2,2-bis(hydroxymethyl)-2,2′,2″-nitrilotriethanol. Preferred of these are ethanolamine, diethanolamine, triethanolamine, 3-piperidino-1,2-propane diol, 3-pyrrolidino-1,2-propane diol, and 2,2-bis(hydroxymethyl)-2,2′,2″-nitrilotriethanol. The alkanolamines may be used alone or in admixture.

When the basic compound is used, it is preferably added in an amount of up to 150 mol %, more preferably 20 to 120 mol %, relative to the surfactant. More than 150 mol % of the basic compound may sometimes fail to remove the resist residues. When the basic compound used is an alkanolamine of up to 10 carbon atoms, an addition amount of 10 to 50 mol %, relative to the surfactant, is most preferred.

In a further preferred embodiment, an amide derivative may be added to the rinse for reducing the surface tension thereof for anti-foaming purpose. Amide derivatives of up to 8 carbon atoms are preferred. With such an amide derivative added, the rinse may become appropriate to discharge on rotating wafers.

Illustrative examples of suitable amide derivatives include formamide, acetamide, propionamide, isobutylamide, hexaneamide, succinamide, succinimide, 2-pyrrolidinone, δ-valerolactam, N-methylformamide, N-methylacetamide, N-ethylacetamide, N-methylsuccinimide, N,N-dimethylformamide, N,N-dimethylacetamide, 1-methyl-2-pyrrolidinone, 1-methyl-2-piperidone, 1,3-dimethyl-2-imidazolidinone, and 1,3-dimethyl-2,4,6-(1H,3H,5H)-pyrimidinetrione. Of these, 2-pyrrolidinone, N-methylsuccinimide, N,N-dimethylformamide, N,N-dimethylacetamide, 1-methyl-2-pyrrolidinone, 1-methyl-2-piperidone, and 1,3-dimethyl-2-imidazolidinone are preferred. The amide derivatives may be used alone or in admixture.

The amide derivative is preferably added in an amount of up to 10% by weight, more preferably 0.5 to 5% by weight based on the weight of the water-soluble polymer. More than 10 wt % of the amide derivative can alter the profile of resist pattern.

The rinse of the invention is suited for use in a lithographic process using resists. Specifically, it is useful in a lithographic process using acid-catalyzed or chemically amplified, positive or negative resist compositions comprising, for example, polymers or copolymers of acrylates or alpha-substituted acrylates having an adamantane structure and an acid-labile protective group in the ester moiety, polymers or copolymers of acrylates or alpha-substituted acrylates having a norbornane structure and an acid-labile protective group in the ester moiety, polymers or copolymers of cyclohexylmaleimide, polymers having a cellulose structure in the main chain which undergoes cleavage under the action of an acid, polyvinyl alcohol or polyvinyl alcohol derivatives. More specifically, the rinse is useful when the resist which has been developed with an aqueous alkaline solution is rinsed to form a resist pattern.

While the resists which are used in micropatterning using deep-UV (248-193 nm), excimer laser beams, x-rays or electron beams among many types of high-energy radiation are desired to form resist patterns which contain minimal defects, the rinse of the invention satisfies this requirement.

In a resist pattern-forming process involving a series of steps as described below, the rinse of the invention is advantageously used in the rinsing step thereof.

A first embodiment is a process for forming a resist pattern, comprising the steps of (a) applying a resist material onto a substrate to form a resist film, (b) prebaking the resist film, (c) exposing the prebaked resist film to a pattern of light, (d) post-exposure baking the exposed resist film, (e) developing the post-baked resist film with an aqueous alkaline solution, and (f) rinsing the developed resist film with a rinse and further with deionized water.

A second embodiment is a process for forming a resist pattern, comprising the foregoing steps (a) to (e), and the step (g) of rinsing the developed resist film with deionized water, then with a rinse, and further with deionized water.

In either of these processes, the rinse of the invention is advantageously used in the rinsing step (f) or (g).

The steps (a) to (e) may follow the well-known lithography technology. For example, a resist composition is applied onto a substrate such as a silicon wafer by spin coating or the like to form a resist film having a thickness of 0.2 to 2.0 μm, which is then pre-baked (PB) on a hot plate at 60 to 150° C. for 1 to 10 minutes, and preferably at 80 to 130° C. for 1 to 5 minutes.

A mask having the desired pattern is then placed over the resist film, and the film exposed through the mask to an electron beam or to high-energy radiation such as deep-UV, excimer laser, or x-rays in a dose of about 1 to 200 mJ/cm², and preferably about 5 to 100 mJ/cm², then post-exposure baked (PEB) on a hot plate at 60 to 150° C. for 1 to 5 minutes, and preferably at 80 to 130° C. for 1 to 3 minutes.

Then development is carried out using as the developer an aqueous alkaline solution, such as a 0.1 to 5% (preferably 2 to 3%) aqueous solution of tetramethylammonium hydroxide (TMAH), this being done by a conventional method such as dip, puddle, or spray method for a period of 0.1 to 3 minutes, and preferably 0.5 to 2 minutes. These steps result in the formation of the desired pattern on the substrate.

Step (f) may be performed by the following procedure, for example. After the development, the wafer is rotated to spin off the developer, and with rotation continued preferably at 100 rpm or higher, the rinse of the invention is cast to flow on the surface of the wafer to be rinsed over 5 to 60 seconds, preferably 10 to 30 seconds. A rinsing time of less than 5 seconds may be too short to fully remove the resist residues whereas a rinsing time of more than 60 seconds may increase the cost. A rotational speed of less than 100 rpm may be too slow to fully remove the resist residues. The upper limit of rotational speed is generally about 3,000 rpm due to the restrictions on the apparatus. The rotational speed need not be constant and may be increased or decreased during the rinsing step. Further rinsing with deionized water may be performed in the same manner as in the conventional lithographic process.

In an alternative embodiment, the rinsing step (g) following development is carried out, after spinning off the developer as in step (f), by rinsing with deionized water, then rinsing with the rinse of the invention, and further rinsing with deionized water. The rinsing with the rinse of the invention in step (g) is the same as in step (f). Previous and subsequent rinsings with deionized water may be performed in the same manner as in the conventional lithographic process.

### EXAMPLE

Examples of the invention are given below by way of illustration and not by way of limitation.

### Examples 1 to 11

Rinse liquids A to K were prepared by dissolving amounts of ingredients (water-soluble polymer and optionally, surfactant, amine and amide) as shown in Table 1 in ultrapure water of the semiconductor manufacturing grade.

A resist of the type shown in Table 2 was spin coated onto a SiON-coated silicon wafer, so as to give a film thickness of 0.4 μm. The resist-coated silicon wafer was prebaked (PB) for 60 seconds on a hot plate at a temperature suitable for forming an optimum pattern (see Table 2). The resist film was exposed imagewise using a suitable light source selected for a particular type of resist used, a KrF excimer laser scanner (Nikon Corp., NA=0.68) for the KrF resist or an ArF excimer laser scanner (Nikon Corp., NA=0.68) for the ArF resist. This was followed by post-exposure baking (PEB) for 60 seconds at a temperature suitable for forming an optimum pattern (see Table 2) and development in an aqueous solution of 2.38% tetramethylammonium hydroxide.

It is noted that the resist pattern formed was a 150-nm line-and-space pattern for the KrF resist and a 100-nm line-and-space pattern (1:1) or a 150-nm contact hole pattern (1:9) for the ArF resist as shown in Table 2.

After the development, the resist film was rinsed with the rinse liquids A to K according to either of the following two procedures.

Rinsing Procedure (1):

The resist film as developed was rinsed with the rinse listed in Table 1 and then with deionized water.

Rinsing Procedure (2):

The resist film as developed was rinsed with deionized water, then with the rinse listed in Table 1 and further with deionized water.

For comparison purposes, the resist film was rinsed by the following procedure.

Rinsing Procedure (3):

The resist film as developed was rinsed with deionized water.

Using a wafer appearance inspection instrument WIN-WIN50 Model 1200L (Accretech Microtechnology Co., Ltd.), the line-and-space (L/S) pattern or contact hole (CH) pattern of the resist patterns resulting from rinsing by the three procedures was observed for counting the number of defects.

TABLE 1

| | | | Polymer | Surfactant | | |
|---|---|---|---|---|---|---|
| | | Solids*¹ | [content | [content | | |
| | Rinse | concentration | (wt %) | (wt %) | Amine | Amide |
| Example | liquid | (wt %) | in solids] | in solids] | [addition amount*²] | [addition amount*³] |
| 1 | A | 2 | a | | | |
| | | | [100] | | | |
| 2 | B | 2 | b | | | |
| | | | [100] | | | |
| 3 | C | 2 | C | | | |
| | | | [100] | | | |
| 4 | D | 2 | d | | | |
| | | | [100] | | | |
| 5 | E | 2 | e | | | |
| | | | [100] | | | |
| 6 | F | 2 | a | | | pyrrolidinone |
| | | | [100] | | | [1 wt %] |
| 7 | G | 2.5 | a | X | | |
| | | | [70] | [30] | | |
| 8 | H | 2.5 | a | X | 2-aminoethanol | |
| | | | [70] | [30] | [20 mol %] | |
| 9 | I | 2.5 | a | X | 2-aminoethanol | pyrrolidinone |
| | | | [70] | [30] | [20 mol %] | [1.4 wt %] |
| 10 | J | 2.5 | a | X | 2-aminoethanol | pyrrolidinone |
| | | | [30] | [70] | [20 mol %] | [3.5 wt %] |
| 11 | K | 2.5 | a | Y | | pyrrolidinone |
| | | | [50] | [50] | | [3.5 wt %] |

*¹polymer + surfactant
*²proportion (mol %) of amine relative to surfactant
*³proportion (wt %) of amide relative to water-soluble polymer

Polymer a: poly(N-vinyl pyrrolidone),
   Luviskol® K-90 by BASF AG
Polymer b: N-vinyl pyrrolidone/vinyl acetate (60/40) copolymer, Luviskol® VA-64 by BASF AG
Polymer c: vinyl alcohol/vinyl acetate (60/40) copolymer,
   Poval SMR-8M by Shin-Etsu Chemical Co., Ltd.
Polymer d: polyacrylic acid,
   Jurymer® AC-10P by Nihon Junyaku Co., Ltd.
Polymer e: pullulan, Pullulan PI-20 by Hayashibara Co., Ltd.
Surfactant X: perfluorooctanesulfonic acid

Surfactant Y: tetraethylammonium perfluorooctanesulfonate

TABLE 2

| | Rinse | | PB | Light | Mask | PEB | Rinsing | Number of |
|---|---|---|---|---|---|---|---|---|
| Example | liquid | Resist | temp. | source | pattern | temp. | procedure | defects |
| 1 | A | SAIL-G28 | 100° C. | ArF | 150 nmC/H | 100° C. | (1) | <25 |
| | | | | | | | (2) | <25 |
| | | | | | | | (3) | >2000 |
| 2 | B | SAIL-X108 | 115° C. | ArF | 100 nmL/S | 110° C. | (1) | <25 |
| | | | | | | | (2) | <25 |
| | | | | | | | (3) | >2000 |
| 3 | C | SEPR-402 | 100° C. | KrF | 150 nmL/S | 110° C. | (1) | <25 |
| | | | | | | | (2) | <25 |
| | | | | | | | (3) | >500 |
| 4 | D | SEPR-402 | 100° C. | KrF | 150 nmL/S | 110° C. | (1) | <25 |
| | | | | | | | (2) | <25 |
| | | | | | | | (3) | >500 |
| 5 | E | SEPR-402 | 100° C. | KrF | 150 nmL/S | 110° C. | (1) | <25 |
| | | | | | | | (2) | <25 |
| | | | | | | | (3) | >500 |
| 6 | F | SEPR-402 | 100° C. | KrF | 150 nmL/S | 110° C. | (1) | <25 |
| | | | | | | | (2) | <25 |
| | | | | | | | (3) | >500 |
| 7 | G | SEPR-402 | 100° C. | KrF | 150 nmL/S | 110° C. | (1) | <25 |
| | | | | | | | (2) | <25 |
| | | | | | | | (3) | >500 |
| 8 | H | SEPR-402 | 100° C. | KrF | 150 nmL/S | 110° C. | (1) | <25 |
| | | | | | | | (2) | <25 |
| | | | | | | | (3) | >500 |
| 9 | I | SEPR-402 | 100° C. | KrF | 150 nmL/S | 110° C. | (1) | <25 |
| | | | | | | | (2) | <25 |
| | | | | | | | (3) | >500 |
| 10 | J | SAIL-G28 | 100° C. | ArF | 150 nmC/H | 100° C. | (1) | <25 |
| | | | | | | | (2) | <25 |
| | | | | | | | (3) | >2000 |
| 11 | K | SAIL-X108 | 115° C. | ArF | 100 nmL/S | 110° C. | (1) | <25 |
| | | | | | | | (2) | <25 |
| | | | | | | | (3) | >2000 |

SAIL-G28: chemically amplified positive resist for ArF exposure, by Shin-Etsu Chemical Co., Ltd.
SAIL-X108: chemically amplified positive resist for ArF exposure, by Shin-Etsu Chemical Co., Ltd.
SEPR-402: chemically amplified positive resist for KrF exposure, by Shin-Etsu Chemical Co., Ltd.

Japanese Patent Application No. 2004-188253 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A rinse for use in a lithographic process with resist, comprising a water-soluble polymer.

2. The rinse of claim 1, wherein said water-soluble polymer is selected from the group consisting of N-vinylpyrrolidone homopolymers, copolymers of N-vinylpyrrolidone with another vinyl monomer, polyvinyl alcohol, copolymers of vinyl alcohol with another vinyl monomer, poly(meth)acrylic acids, and polysaccharides.

3. The rinse of claim 1, further comprising a surfactant.

4. The rinse of claim 3, wherein said surfactant comprises a fluoroalkanesulfonic acid derivative or alkanesulfonic acid derivative.

5. A process for forming a resist pattern, comprising the steps of:
(a) applying a resist material onto a substrate to form a resist film,
(b) prebaking the resist film,
(c) exposing the prebaked resist film to a pattern of light,
(d) post-exposure baking the exposed resist film,
(e) developing the post-baked resist film with an aqueous alkaline solution, and
(f) rinsing the developed resist film with the rinse of claim 1, and further with deionized water.

6. A process for forming a resist pattern, comprising the steps of:
(a) applying a resist material onto a substrate to form a resist film,
(b) prebaking the resist film,
(c) exposing the prebaked resist film to a pattern of light,
(d) post-exposure baking the exposed resist film,
(e) developing the post-baked resist film with an aqueous alkaline solution, and
(g) rinsing the developed resist film with deionized water, then with the rinse of claim 1, and further with deionized water.
